(19) United States
(12) Patent Application Publication
(10) Pub. No.: US 2023/0264619 A1
(43) Pub. Date: Aug. 24, 2023

(54) Heating And Cooling Device

(71) Applicant: George MacLauchlan, Madison, CT (US)

(72) Inventor: George MacLauchlan, Madison, CT (US)

(21) Appl. No.: 17/679,206

(22) Filed: Feb. 24, 2022

(51) Int. Cl. B60N 3/10; F25D 31/00

(52) U.S. Cl. CPC B60N 3/104; F25D 31/007; F25D 31/005

(57) ABSTRACT

A heating and cooling device includes a heating and cooling module, which is positionable in a cupholder of a vehicle. A power and signal cable is operationally engaged to and extends from the heating and cooling module. A controller is engaged to the power and signal cable distal from the heating and cooling module. The controller selectively signals the heating and cooling module to execute at least one heating mode and at least one cooling mode. The heating and cooling module thus can selectively heat or cool a beverage that is positioned in a cup within the cupholder. A power cord is engaged to and extends from the controller. A plug is engaged to the power cord distal from the controller. The plug is insertable into a power port of the vehicle to power the heating and cooling module.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to temperature control devices and more particularly pertains to a new temperature control device for selectively heating and cooling a beverage positioned in cupholder of a vehicle. The present invention discloses a temperature control device comprising a disc shaped heating and cooling module, which is sized for insertion into a cup holder of an automobile, and which has a controller in its power cord for temperature selection.

### (2) Description of Related Art including information disclosed under 37 CFR 1.97 and 1.98.

The prior art relates to temperature control devices. Prior art temperature control devices may comprise sleeves and cylinders into which cups are positionable for one or more of heating and cooling beverages within the cups. The prior art also may comprise cups having integrated heaters and heaters which are attachable to bottoms of cups. What is lacking in the prior art is a disc shaped heating and cooling module, which is sized for insertion into a cup holder of an automobile, and which has a controller in its power cord for temperature selection.

### BRIEF SUMMARY OF THE INVENTION

An embodiment of the disclosure meets the needs presented above by generally comprising a heating and cooling module, which is configured to be positioned in a cupholder of a vehicle. A power and signal cable is operationally engaged to and extends from the heating and cooling module. A controller is engaged to the power and signal cable distal from the heating and cooling module. The controller is configured to selectively signal the heating and cooling module to execute at least one heating mode and at least one cooling mode. The heating and cooling module thus is configured to selectively heat or to cool a beverage that is positioned in a cup within the cupholder. A power cord is engaged to and extends from the controller. A plug is engaged to the power cord distal from the controller. The plug is configured to be inserted into a power port of the vehicle to power the heating and cooling module.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a heating and cooling device according to an embodiment of the disclosure.

FIG. 2 is a bottom view of an embodiment of the disclosure.

FIG. 3 is an in-use view of an embodiment of the disclosure.

FIG. 4 is a detail view of an embodiment of the disclosure.

### DETAILED DESCRIPTION OF THE INVENTION

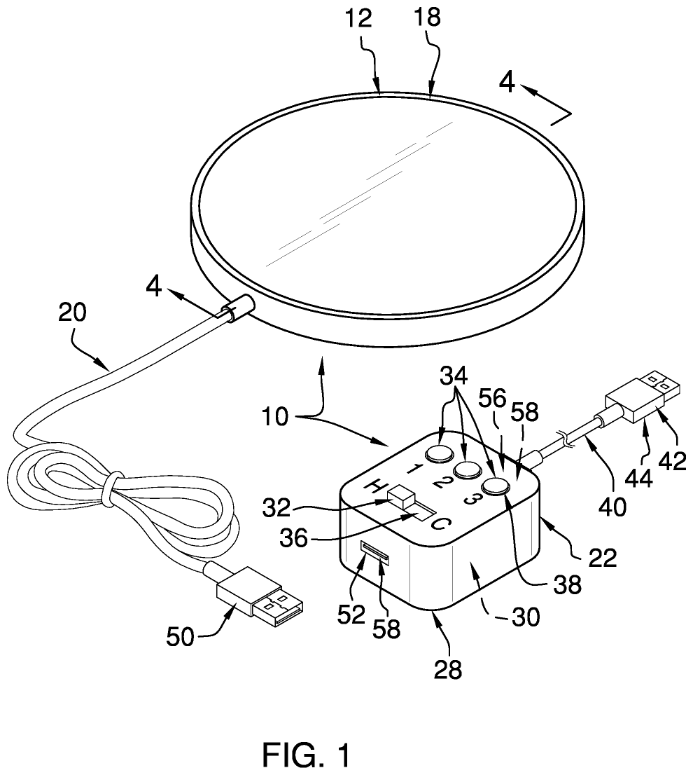

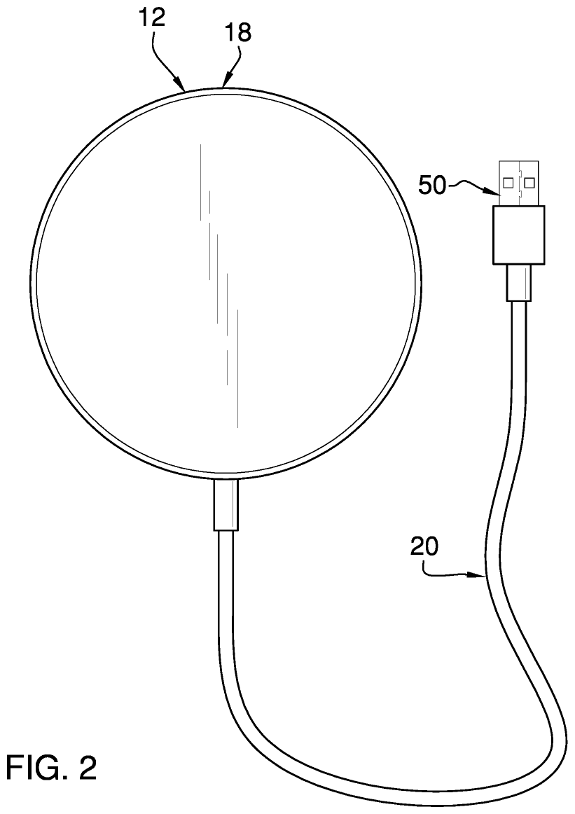

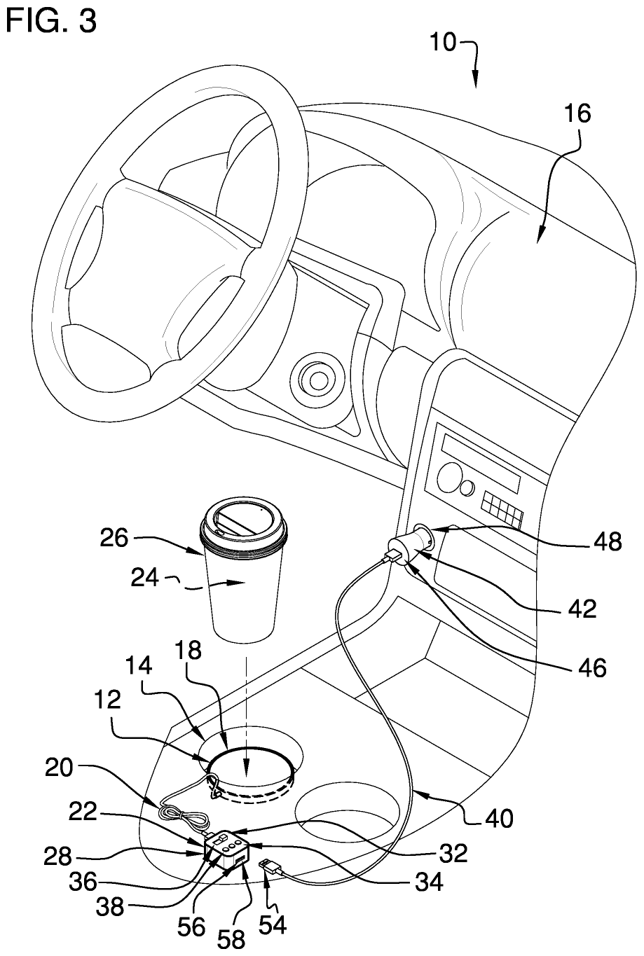

With reference now to the drawings, and in particular to FIGS. 1 through 4 thereof, a new temperature control device embodying the principles and concepts of an embodiment of the disclosure and generally designated by the reference numeral 10 will be described.

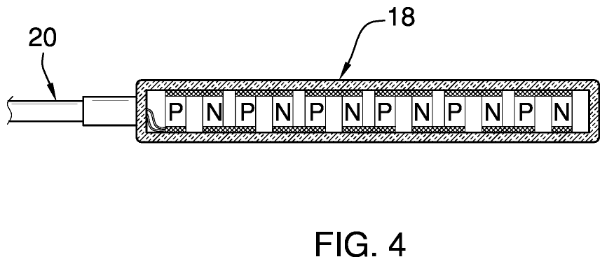

As best illustrated in FIGS. 1 through 4, the heating and cooling device 10 generally comprises a heating and cooling module 12, which is configured to be positioned in a cupholder 14 of a vehicle 16. The present invention also anticipates the heating and cooling module 12 being integral to the cupholder 14. The heating and cooling module 12 may be disc shaped, or alternatively shaped so as to match the cupholder 14, such as, but not limited to, oval, square, and the like. The heating and cooling module 12 comprises a thermoelectric heat pump 18, as shown in FIG. 4.

A power and signal cable 20 is operationally engaged to and extends from the heating and cooling module 12. A controller 22 is engaged to the power and signal cable distal from the heating and cooling module 12. The controller 22 is configured to selectively signal the heating and cooling module 12 to execute at least one heating mode and at least one cooling mode. The heating and cooling module 12 thus is configured to selectively heat or to cool a beverage 24 that is positioned in a cup 26 within the cupholder 14.

The controller 22 comprises a housing 28, which defines an interior space 30. A primary switch 32 and a plurality of secondary switches 34 are engaged to the housing 28. The primary switch 32, which may comprise a toggle switch 36, is configured for switching the heating and cooling module 12 between the at least one heating mode and the at least one cooling mode. The present invention also anticipates the primary switch 32 having an OFF mode. Each secondary switch 34, which may comprise a depressible button 38, is configured for selection of one of a low power mode, a medium power mode, and a high power mode for the heating and cooling module 12. As will be apparent to those skilled in the art of switches, a variety of switching means are available for fulfilling the requirements of the present invention.

A power cord 40 is engaged to and extends from the controller 22. A plug 42 is engaged to the power cord 40 distal from the controller 22. The plug 42 comprises a Universal Serial Bus Plug 44, as shown in FIG. 1, an automobile auxiliary power plug 46, as shown in FIG. 4, or the like. The plug 42 is configured to be inserted into a power port 48 of the vehicle 16 to power the heating and cooling module 12. With the heating and cooling module 12 being integral to the cupholder 14, the power cord 40 and controller 22 also would be integral to the vehicle 16.

The heating and cooling device 10 also may comprise a first connector 50, which is engaged to the power and signal cable 20 distal the heating and cooling module 12. A second connector 52 is operationally engaged to the controller 22. The second connector 52 is complementary to the first connector 50 and thus is positioned to selectively engage the first connector 50 to operationally engage the controller 22 to the heating and cooling module 12.

The heating and cooling device 10 also may comprise a third connector 54, which is engaged to the power cord 40 distal from the plug 42. A fourth connector 56 is operationally engaged to the controller 22. The fourth connector 56 is complementary to the third connector 54 and thus is positioned to selectively engage the third connector 54 to operationally engage the controller 22 to the plug 42. Each of the second connector 52 and the fourth connector 56 may comprise a Universal Serial Bus Port 58.

In use, the heating and cooling module 12 is positioned in the cupholder 14. The power and signal cable 20 and the power cord 40 are engaged to the controller 22. The plug 42 of the power cord 40 then is inserted into the power port 48 to powering the heating and cooling module 12. A cup 26 containing a beverage 24 can then be inserted into the cupholder 14. A user then uses the controller 22 to select either the heating mode or the cooling mode and one of the low power mode, the medium power mode, and the high power mode for the heating and cooling module 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A heating and cooling device comprising:
a heating and cooling module configured to be positioned in a cupholder of a vehicle;
a power and signal cable operationally engaged to and extending from the heating and cooling module;
a controller engaged to the power and signal cable distal from the heating and cooling module, the controller being configured for selectively signaling the heating and cooling module for executing at least one heating mode and at least one cooling mode, wherein the heating and cooling module is configured for selectively heating or cooling a beverage positioned in a cup within the cupholder;
a power cord engaged to and extending from the controller;
a plug engaged to the power cord distal from the controller and being configured for insertion into a power port of the vehicle for powering the heating and cooling module: and
wherein the controller comprises
a housing defining an interior space, the power and signal cable being. removably enageable to the housing for connecting the power and signal cable to the controller,
a primary switch engaged to the housing and being configured for switching the heating and cooling module between the at least one heating mode and the at least one cooling mode, and
a plurality of secondary switches engaged to the housing, each secondary switch being configured for selecting one of a low power mode, a medium power mode, and a high power mode of the heating and cooling module.

2. The heating and cooling device of claim 1, wherein the heating and cooling module is disc shaped.

3. The heating and cooling device of claim 1, wherein the heating and cooling module comprises a thermoelectric heat pump,

4. (canceled)

5. The heating and cooling device of claim 1, wherein the primary switch comprises a toggle switch.

6. The heating and cooling device of claim 1 wherein each secondary switch comprises a depressible button.

7. The heating and cooling device of claim 1, wherein the plug comprises a Universal Serial Bus Plug or an automobile auxiliary power plug.

8. The heating and cooling device of claim 1, further including:
a first connector engaged to the power and signal cable distal the heating and cooling module;
a second connector operationally engaged to the controller, the second connector being complementary to the first connector, such that the second connector is positioned for selectively engaging the first connector for operationally engaging the controller to the heating and cooling module;
a third connector engaged to the power cord distal from the plug; and
a fourth connector operationally engaged to the controller, the fourth connector being complementary to the third connector, such that the fourth connector is positioned for selectively engaging the third connector for operationally engaging the controller to the plug.

9. The heating and cooling device of claim 8, wherein each of the second connector and the fourth connector comprise a Universal Serial Bus Port.

10. A heating and cooling system comprising:
a vehicle comprising a cupholder and a power port;
a cup containing a beverage;
a heating and cooling module positioned in the cupholder;
a power and signal cable operationally engaged to and extending from the heating and cooling module;
a controller engaged to the power and signal cable distal from the heating and cooling module, the controller being configured for selectively signaling the heating and cooling module for executing at least one heating mode and at least one cooling mode, such that the heating and cooling module is positioned for selectively heating or cooling the beverage;
a power cord engaged to and extending from the controller, a plug of the power cord being inserted into the power port for powering the heating and cooling module; and
wherein the controller comprises
a housing defining an interior space, the power and signal cable being removably engageable to the housing for connecting the power and signal cable to the controller,
a primary switch engaged to the housing and being configured for switching the heating and cooling module between the at least one heating mode and the at least one cooling mode. and
a plurality of secunda switches engaged to the housing, each secondary switch being configured for selecting one of a low power mode, a medium power mode, and a high power mode of the heating and cooling module.

11. The heating and cooling device of system ofclaim 10, wherein the heating and cooling module is disc shaped.

12. The heating and cooling device of system of claim 10, wherein the heating and cooling module comprises a thermoelectric heat pump.

13. (canceled)

14. The heating and cooling device of system of claim 10, wherein the primary switch comprises a toggle switch.

15. The heating and cooling device of system of claim 10, wherein each secondary switch comprises a depressible button.

16. The heating and cooling device of system of claim 10, wherein the plug comprises a Universal Serial Bus Plug or an automobile auxiliary power plug.

17. The heating and cooling device of system of claim 10, further including:
a first connector engaged to the power and signal cable distal the heating and cooling module;
a second connector operationally engaged to the controller, the second connector being complementary to the first connector, such that the second connector is positioned for selectively engaging the first connector for operationally engaging the controller to the heating and cooling module;
a third connector engaged to the power cord distal from the plug; and
a fourth connector operationally engaged to the controller, the fourth connector being complementary to the third connector, such that the fourth connector is positioned for selectively engaging the third connector for operationally engaging the controller to the plug.

18. The heating and cooling system of claim 17, wherein each of the second connector and the fourth connector comprise a Universal Serial Bus Port.

19. A heating and cooling device comprising:
a heating and cooling module configured to be positioned in a cupholder of a vehicle, the heating and cooling module being disc shaped, the heating and cooling module comprising a thermoelectric heat pump;
a power and signal cable operationally engaged to and extending from the heating and cooling module;
a controller engaged to the power and signal cable distal from the heating and cooling module, the controller being configured for selectively signaling the heating and cooling module for executing at least one heating mode and at least one cooling mode, wherein the heating and cooling module is configured for selectively heating or cooling a beverage positioned in a cup within the cupholder, the controller comprising:
a housing defining an interior space, the power and signal cable being removably engageable to the housing for connectins the power and signal cable to the controller,
a primary switch engaged to the housing and being configured for switching the heating and cooling module between the at least one heating mode and the at least one cooling mode, the primary switch comprising a toggle switch, and
a plurality of secondary switches engaged to the housing, each secondary switch being configured for selecting one of a low power mode, a medium power mode, and a high power mode of the heating and cooling module, each secondary switch comprising a depressible button;
a first connector engaged to the power and signal cable distal the heating and cooling module;
a second connector operationally engaged to the controller, the second connector being complementary to the first connector, such that the second connector is positioned for selectively engaging the first connector for operationally engaging the controller to the heating and cooling module;
a power cord engaged to and extending from the controller;
a plug engaged to the power cord distal from the controller and being configured for insertion into a power port of the vehicle for powering the heating and cooling module, the plug comprising a Universal Serial Bus Plug or an automobile auxiliary power plug;
a third connector engaged to the power cord distal from the plug; and
a fourth connector operationally engaged to the controller, the fourth connector being complementary to the third connector, such that the fourth connector is positioned for selectively engaging the third connector for operationally engaging the controller to the plug, each of the fourth connector and the second connector comprising a Universal Serial Bus Port.
